(19) United States
(12) Patent Application Publication
(10) Pub. No.: US 2011/0188169 A1
(43) Pub. Date: Aug. 4, 2011

(54) Electric double layer capacitor cell, electric double layer capacitor package having the same, and methods of manufacturing the same

(75) Inventors: Dong Sup Park, Suwon (KR); Wan Suk Yang, Seoul (KR); Seung Dae Baek, Yongin (KR); Yeong Su Cho, Guri (KR); Sang Kyun Lee, Suwon (KR); Sang Cheol Koh, Seongnam (KR)

(73) Assignee: SAMSUNG ELECTRO-MECHANICS CO., LTD., Suwon (KR)

(21) Appl. No.: 12/929,572

(22) Filed: Feb. 1, 2011

(30) Foreign Application Priority Data
Feb. 2, 2010 (KR) 10-2010-0009686

(51) Int. Cl. H01G 4/30

(52) U.S. Cl. 361/301.4; 29/25.41

(57) ABSTRACT

There are provided an electric double layer capacitor cell, an electric double layer capacitor package having the same, and methods of manufacturing the same. An electric double layer capacitor cell according to an aspect of the invention may include: a plurality of electric double layer capacitor unit cells stacked upon each other, wherein each of the plurality of electric double layer capacitor unit cells includes first and second current collectors having first and second lead terminal portions, respectively, first and second electrodes provided on the first and second current collectors, respectively, and a separator provided between the first and second electrodes, and the first and second electrode lead terminal portions each are combined into one to provide first and second bonding portions being connected to external terminals provided to apply electricity to the electric double layer capacitor unit cells.

### CROSS-REFERENCE TO RELATED APPLICATIONS

This application claims the priority of Korean Patent Application No. 2010-0009686 filed on Feb. 2, 2010, in the Korean Intellectual Property Office, the disclosure of which is incorporated herein by reference.

### BACKGROUND OF THE INVENTION

1. Field of the Invention

The present invention relates to an electric double layer capacitor cell, an electric double layer capacitor package having the same, and methods of manufacturing the same, and more particularly, to an electric double layer capacitor cell having low resistance and excellent reliability, an electric double layer capacitor package having the same, and methods of manufacturing the same.

2. Description of the Related Art

A stable energy supply plays an important role in various kinds of electronic products such as information-communications apparatuses. In general, such a function is implemented by a capacitor. That is, a capacitor collects electricity from circuits of information-communication apparatuses and various kinds of electronic products, and sends out the collected electricity. Further, the capacitor stabilizes the flow of electricity inside the circuits. A general capacitor takes a very short period of time to charge and discharge, has high output density and at the same time, low energy density. For these reasons, the use of general capacitors as storage devices is limited.

In order to overcome these limitations, new'capacitors, such as electric double layer capacitors, which take a short period of time to charge and discharge and have high output density, have been under development. Along with secondary batteries, these capacitors have come to prominence.

An electric double layer capacitor is an energy storage device that uses a pair of electrodes having different polarities, allows for repeated charging and discharging, has high energy efficiency and output, excellent durability, and high stability. Therefore, electric double layer capacitors being charged and discharged with high current have recently emerged as promising electrical storage devices with a large number of charging and discharging cycles, for applications such as auxiliary batteries for cellular phones, auxiliary power supplies for electric automobiles, and auxiliary power supplies for solar batteries.

A basic structure of an electric double layer capacitor consists of an electrode having a relatively large surface area such as a porous electrode, an electrolyte, a current collector, and a separator. The electric double layer capacitor having this structure operates according to an electrochemical mechanism in which a voltage of a few volts is applied to both ends of a unit cell electrode so that ions inside the electrolyte move under an electric field and are adsorbed onto the surface of the electrode.

### SUMMARY OF THE INVENTION

An aspect of the present invention provides an electric double layer capacitor cell having low resistance and excellent reliability, an electric double layer capacitor package having the same, and methods of manufacturing the same.

According to an aspect of the present invention, there is provided an electric double layer capacitor cell including: a plurality of electric double layer capacitor unit cells stacked upon each other, wherein each of the plurality of electric double layer capacitor unit cells includes first and second current collectors having first and second lead terminal portions, respectively, first and second electrodes provided on the first and second current collectors, respectively, and a separator provided between the first and second electrodes, and the first and second electrode lead terminal portions each are combined into one to provide first and second bonding portions being connected to external terminals provided to apply electricity to the electric double layer capacitor unit cells.

Each of the first and second bonding portions may be combined by rolling.

The first and second bonding portions may have curved portions.

According to another aspect of the present invention, there is provided an electric double layer capacitor package including: an external case having a storage space therein and formed of insulating resin; first and second external terminals buried within the external case and each having a first surface being exposed to the storage space and a second surface being exposed to an outside area of the external case; and an electric double layer capacitor cell disposed in the storage space and having a plurality of electric double layer capacitor unit cells stacked upon each another, wherein each of the plurality of electric double layer capacitor unit cells includes first and second current collectors having first and second lead terminal portions, respectively, first and second electrodes provided on the first and second current collectors, respectively, and a separator provided between the first and second electrodes, the first and second lead terminal portions each are combined into one to provide first and second bonding portions, respectively, and the first and second bonding portions are electrically connected to the first surfaces of the first and second external terminals, respectively.

The first and second bonding portions may be combined by rolling.

The first and second bonding portions may have curved portions.

The first and second bonding portions may be connected to the first surfaces of the first and second external terminals, respectively, by ultrasonic welding.

The external case may be provided by molding the insulating resin and the first and second external terminals into a single body by insert injection molding.

The first and second external terminals may be provided on the same surface of the external case.

The external case may have a storage space having an open top, a lower case having the first and second external terminals buried therein, and an upper cap mounted on the lower case to cover the storage space.

According to another aspect of the present invention, there is provided a method of manufacturing an electric double layer capacitor cell, the method including: stacking a plurality of electric double layer capacitor unit cells each having first and second current collectors including first and second lead terminal portions, respectively, first and second electrodes formed on the first and second current collectors, respectively, and a separator formed between the first and second electrodes; and combining the first and second lead terminal portions into one to form respective first and second bonding portions, the first and second bonding portions connected to external terminals provided to apply electricity to the electric double layer capacitor unit cells.

The first and second bonding portions may be formed by rolling.

According to another aspect of the present invention, there is provided a method of manufacturing an electric double layer capacitor package, the method including: molding insulating resin and first and second external terminals into a single body to thereby form a lower case having a storage space with an open top so that the first and second external terminals have first surfaces exposed to the storage space and second surfaces exposed to an outside area of the lower case; stacking a plurality of electric double layer capacitor unit cells each having first and second current collectors including first and second lead terminal portions, respectively, first and second electrodes formed on the first and second current collectors, respectively, and a separator formed between the first and second electrodes; combining the first and second lead terminal portions into one to form respective first and second bonding portions to thereby prepare an electric double layer capacitor cell having the first and second bonding portions; disposing the electric layer capacitor cell within the storage space; electrically connecting the first and second bonding portions to the first surfaces of the first and second external terminals; and mounting an upper cap on the lower case to cover the storage space.

The first and second bonding portions may be formed by rolling.

The first and second boding portions and the first surfaces of the first and second external terminals may be connected by ultrasonic welding.

The lower case may be formed by insert injection molding.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating an electric double layer capacitor cell according to an exemplary embodiment of the present invention;

FIG. 2A is a schematic perspective view illustrating an electric double layer capacitor package according to an exemplary embodiment of the present invention;

FIG. 2B is a schematic cross-sectional view illustrating an electric double layer capacitor taken along the line I-I′ of FIG. 2A;

FIGS. 3A and 3B are cross-sectional views illustrating the process flow of a method of manufacturing an electric double layer capacitor cell according to an exemplary embodiment of the present invention; and

FIGS. 4A through 4C are cross-sectional views illustrating the process flow of a method of manufacturing an electric double layer capacitor cell according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

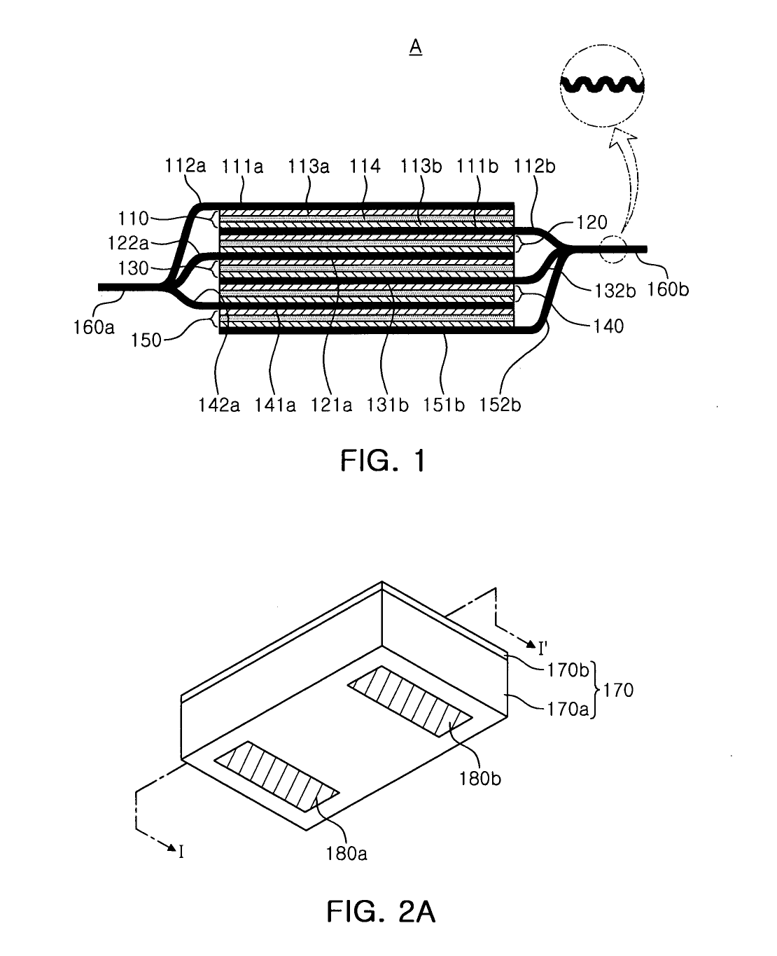

FIG. 1 is a schematic cross-sectional view illustrating an electric double layer capacitor cell A according to an exemplary embodiment of the invention.

Referring to FIG. 1, an electric double layer capacitor cell A according to this embodiment has a plurality of electric double layer capacitor unit cells 110, 120, 130, 140, and 150 stacked upon one another.

The electric double layer capacitor unit cell 110, which is the first electric double layer capacitor unit cell, has a first current collector 111a including a first lead terminal portion 112a, a first electrode 113a, a separator 114, a second electrode 113b, and a second current collector 111b having a second lead terminal portion 112b, which are stacked in a sequential manner.

The first and second current collectors 111a and 111b are conductive sheets used to transmit electrical signals to the first and second electrodes 113a and 113b, respectively.

The conductive sheets may be formed of a conductive polymer, a rubber sheet or metallic foil. The first and second current collectors 111a and 111b have the first and second lead terminal portions 112a and 112b, respectively, where the first and second electrodes 113a and 113b are not formed.

The first and second electrodes 113a and 113b face each other, and electricity of opposite polarities is applied thereto. The first and second electrodes 113a and 113b may be formed of a polarizable electrode material, for example, activated carbon with a relatively large specific area. The first and second electrodes 113a and 113b may be prepared by bonding electrode material slurries principally containing power activated carbon to first and second current collectors 111a and 111b, respectively.

The separator 114 may be formed of a porous material so that ions may pass through the separator 114. The separator 114 may be formed of a porous material including polypropylene, polythene, and glass fibers. However, the present invention is not limited thereto.

As shown in FIG. 1, electrodes may be formed on both surfaces of the second current collector 111b, by which an electric double layer capacitor unit cell 120, which is a second electric double layer capacitor unit cell, can be stacked.

In the same manner, a plurality of electric double layer capacitor unit cells 110, 120, 130, 140, and 150 are stacked upon one another. First lead terminal portions 112a, 122a, and 142a of first current collectors 111a, 121a, and 141a, which form the electric double layer capacitor unit cells 110, 120, 130, 140, and 150, respectively, are combined into one to provide one portion, while second lead terminal portions 112b, 132b, and 152b of second current collectors 111b, 131b, and 151b are also combined into one to form the other portion. That is, the first lead terminal portions are combined into one to thereby form a first bonding portion 160a, while the second lead terminal portions are combined into one to thereby form a second bonding portion 160b. Here, the first and second bonding portions 160a and 160b are connected to external terminals provided to apply electricity to the electric double layer capacitor unit cells.

In general, an electric double layer capacitor cell is electrically connected to an external terminal by a package process. Here, the external terminal is provided to apply electricity to the electric double layer capacitor cell. When a plurality of electric double layer capacitor unit cells are stacked upon one another, a plurality of lead terminal portions need to be connected to external terminals.

According to this embodiment, a plurality of lead terminal portions are combined into one to thereby form a bonding portion, thereby facilitating a connection with an external terminal.

A method of combining a plurality of terminal lead portions may be appropriately selected according to the kind of material that forms current collectors. For example, when a current collector is formed of metallic foil, rolling may be performed.

More specifically, a plurality of lead terminal portions, formed of metallic foil, may be combined into one by cold rolling. Therefore, the first and second bonding portions 160a and 160b may have curved portions.

As shown in FIG. 1, the first and second lead terminal portion may be disposed in opposite directions. However, the present invention is not limited thereto. The first and second lead terminal portions may be disposed in the same direction according to the position of the external terminals applying electricity.

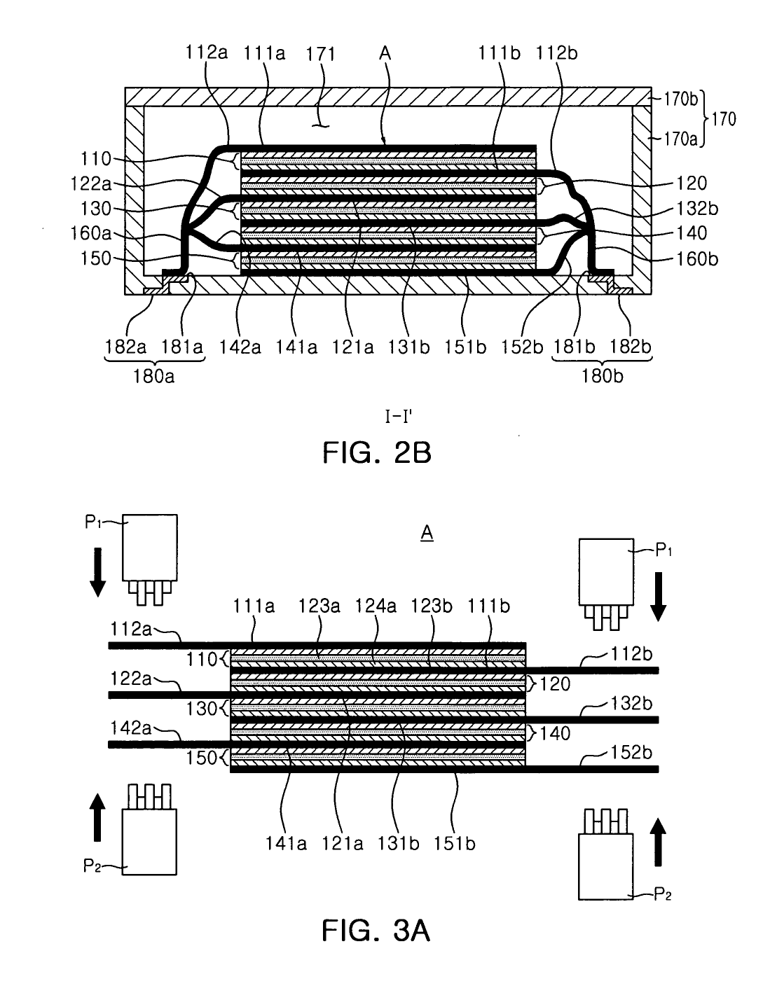

FIG. 2A is a schematic perspective view illustrating an electric double layer capacitor package according to an exemplary embodiment of the invention. FIG. 2B is a schematic cross-sectional view taken along the line I-I′ of the electric double layer capacitor package of FIG. 2A.

Referring to FIGS. 2A and 2B, an electric double layer capacitor package according to this embodiment has a storage space 171 therein, and includes an outer case 170, formed of insulating resin, and the electric double layer capacitor cell A to be disposed in the storage space 171 of the outer case 170.

First and second external terminals 180a and 180b are buried in the outer case 170 in order to apply electricity to the electric double layer capacitor cell A. The first and second external terminals 180a and 180b include first surfaces 181a and 181b, being exposed to the storage space 171, and second surfaces 182a and 182b, being exposed to the outside of the outer case, respectively. The first and second external terminals 180a and 180b connect an outside area of the outer case 170 and an inside area of the storage space 171 to each other.

The outer case 170 may be manufactured using insulating resin by insert injection molding so that the outer case 170 and the first and second external terminals 180a and 180b are molded into a single body.

The electric double layer capacitor cell A is disposed within the storage space 171 of the outer case 170. The chip-type electric double layer capacitor cell A is electrically connected to the first surfaces 181a and 181b of the first and second external terminals 180a and 180b that are exposed to the storage space 171. The first and second external terminals 180a and 180b may be provided in order to electrically connect the electric double layer capacitor cell A to an external power supply.

As shown in FIG. 1, the electric double layer capacitor cell A has the plurality of electric double layer capacitor unit cells 110, 120, 130, 140, and 150 stacked upon each other.

Each of the electric double layer capacitor unit cells includes the first current collector 111a having the first lead terminal portion 112a, the first electrode 113a, the separator 114, the second electrode 113b, and the second current collector 111b having the second lead terminal portion 112b.

The first lead terminal portions 112a, 122a, and 142a of the first current collectors 111a, 121a, and 141a, which form the electric double layer capacitor unit cells 110, 120, 130, 140, and 150, respectively, are combined into one to thereby form the first bonding portion 160a, while the second lead terminal portions 112b, 132b, and 152b of the second current collectors 111b, 131b, and 151b are combined into one to thereby form the second bonding portions 160b.

The first and second bonding portions 160a and 160b are electrically connected to the first surfaces 181a and 181b of the first and second external terminals 180a and 180b, respectively.

The shapes of the first and second bonding portions 160a and 160b may be appropriately changed so that the first and second bonding portions 160a and 160b may be electrically connected to the first and second external terminals 180a and 180b, respectively.

According to an exemplary embodiment of the invention, a plurality of lead terminal portions are combined into one to thereby form a bonding portion, thereby facilitating a connection with an external terminal.

A method of combining a plurality of lead terminal portions into one is not particularly limited.

For example, when current collectors are formed of metallic foil, a plurality of lead terminal portions may be combined into one to thereby form a bonding portion by rolling. However, the present invention is not limited thereto.

More specifically, a plurality of lead terminal portions, formed of metallic foil, may be combined into one by cold rolling. The first and second bonding portions 160a and 160b may thereby have curved portions.

The first and second bonding portions 160a and 160b may be connected to the first surfaces 181a and 181b of the first and second external terminals 180a and 180b, respectively, by ultrasonic welding. The first and second bonding portions 160a and 160b, each of which is formed by combining the lead terminal portions into one, can be easily connected to the first and second external terminals, respectively, and may reduce damage to the package when ultrasonic waves are applied thereto.

Furthermore, coupling between the first and second bonding portions 160a and 160b and the first and second external terminals, respectively, can be improved, leakage of an electrolyte can be prevented, and resistance between the first and second bonding portions and the first and second external terminals, respectively, can be reduced.

Since the first and second external terminals 180a and 180b are formed in the same surface of the outer case, the electric double layer capacitor package itself can be an SMT (surface mount technology) component without using an additional structure. To this end, the first and second external terminals 180a and 180b and the outer case 170 may form one plane.

In this embodiment, the outer case 170 has a storage space having an open top surface, and may include a lower case 170a having the first and second external terminals 180a and 180b buried therein and an upper cap 170b mounted on the lower case 170a so as to cover the storage space.

The outer case 170 may be formed of insulating resin. Here, the insulating resin may be, for example, polyphenylene sulfide (PPS) or liquid crystal polymer (LCP). However, the present invention is not limited thereto. Therefore, the above-described electric double layer capacitor can prevent an internal structure during an SMT process being performed at a high temperature ranging from approximately 240° C. to 270° C.

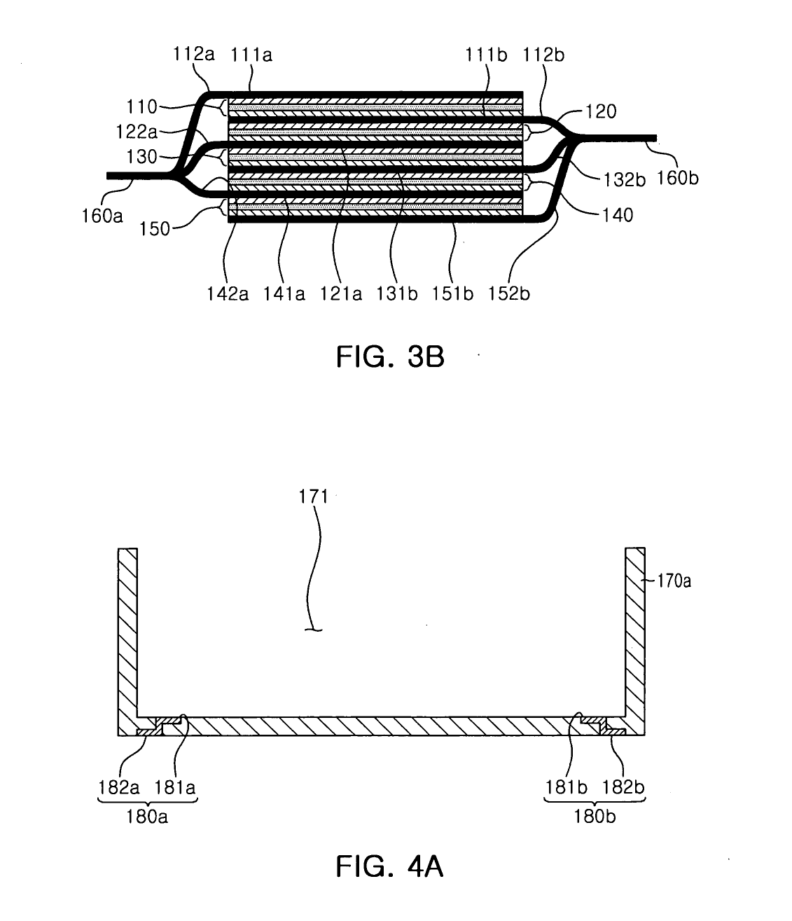

FIGS. 3A through 3B are cross-sectional views illustrating the process flow of a method of manufacturing an electric double layer capacitor cell according to an exemplary embodiment of the present invention.

First, as shown in FIG. 3A, the plurality of electric double layer capacitor unit cells 110, 120, 130, 140, and 150 are stacked to thereby prepare an electric double layer capacitor cell.

The electric double layer capacitor unit cell 110 may be formed by stacking the first current collector 111a of the first lead terminal portion 112a, the first electrode 113a, the separator 114, the second electrode 113b, and the second current collector 111b of the second lead terminal portion 112b in a sequential manner.

As shown in FIG. 3A, electrodes may be formed on both surfaces of the second current collector 111b, by which the electric double layer capacitor unit cell 120, which is the second electric double layer capacitor unit cell, may be stacked. In the same manner, the plurality of electric double layer capacitor unit cells 110, 120, 130, 140, and 150 may be stacked.

The first lead terminal portions 112a, 122a, and 142a of the first current collectors 111a, 121a, and 141a, which form the electric double layer capacitor unit cells 110, 120, 130, 140, and 150, respectively, are combined into one to thereby form the first bonding portion 160a, while the second lead terminal portions 112b, 132b, and 152b of the second current collectors 111b, 131b, and 151b are combined into one to thereby form the second bonding portions 160b. The first and second bonding portions 160a and 160b are provided in order to be electrically connected to external terminals formed to apply electricity to the electric double layer capacitor cell.

A method of combining a plurality of lead terminal portions may be appropriately selected according to the kind of material forming the current collectors. For example, in the case that a current collector is formed of metallic foil, rolling may be performed.

Specifically, as shown in FIG. 3A, hydraulic presses P1 and P2 are disposed at the top and bottom of a group of the first lead terminal portions 112a, 122a, and 142a and a group of the second lead terminal portions 112b, 132b, and 152b, respectively. The first lead terminal portions 112a, 122a, and 142a and the second lead terminal portions 112b, 132b, and 152b are respectively compressed by using the hydraulic presses P1 and P2 and thus are combined into two different portions. Therefore, as shown in FIG. 3B, the first lead terminal portions 112a, 122a, and 142a may be combined into one to thereby form the first bonding portions 160a, while the second lead terminal portions 112b, 132b, and 152b may be combined into one to thereby form the second bonding portion 160b.

Furthermore, the first and second bonding portions 160a and 160b may have curved portions according to the shape of the hydraulic presses.

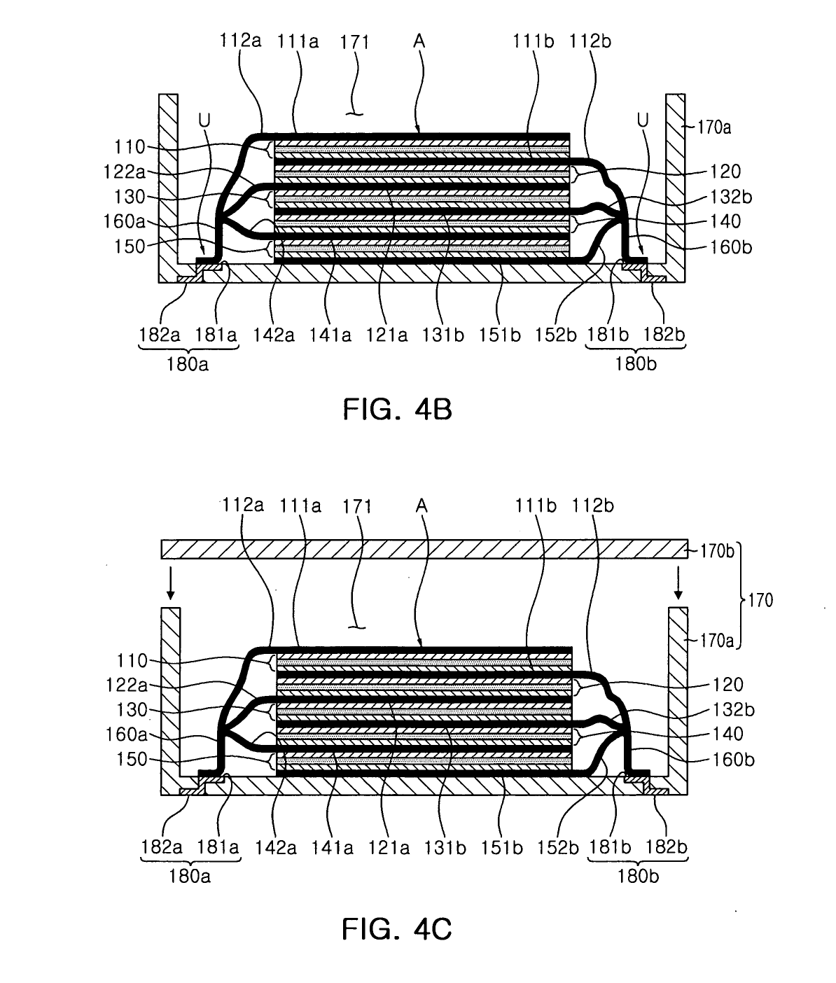

FIGS. 4A through 4C are cross-sectional views illustrating the process flow of a method of manufacturing an electric double layer capacitor package according to an exemplary embodiment of the invention.

First, as shown in FIG. 4A, the lower case 170a has the storage space 171 and the first and second external terminals 180a and 180b buried therein while the first surfaces 181a and 181b are exposed to the storage space 171 and the second surfaces 182a and 182b are exposed to the outside, respectively.

The lower case 170a may be formed using any method, as long as insulating resin and the first and second external terminals 180a and 180b are molded into a single body so that the first and second external terminals 180a and 180b are buried in the insulating material. For example, insert injection molding may be used.

More specifically, first and second external terminals are disposed within a mold having the shape of a lower case, which are then filled with insulating resin. The insulating resin inside the mold is solidified together with the first and second external terminals by cooling or cross-linkage. The insulating material and the first and second external terminals, which are formed of different materials, are molded into a single body by insert injection molding.

Then, as shown in FIG. 4B, the electric double layer capacitor cell A is disposed within the storage space 171 of the lower case 170a.

As described above, the electric double layer capacitor cell A may be prepared as shown in FIGS. 3A and 3B.

The electric double layer capacitor cell A has the plurality of electric double layer capacitor unit cells 110, 120, 130, 140, and 150 stacked upon one another.

The electric double layer capacitor cell A has the first and second bonding portions 160a and 160b. Here, the first lead terminal portions 112a, 122a, and 142a of the first current collectors 111a, 121a, and 141a, which form the electric double layer capacitor unit cells 110, 120, 130, 140, and 150, respectively, are combined into one to form the first bonding portion 160a, while the second lead terminal portions 112b, 132b, and 152b of the second current collectors 111b, 131b, and 151b are combined into one to form the second bonding portion 160b.

Then, the first and second bonding portions 160a and 160b are electrically connected to the first surfaces 181a and 181b of the first and second external terminals 180a and 180b, respectively, which are exposed to the storage space 171.

The shapes of the first and second bonding portions 160a and 160b may be appropriately changed in order to make contact with the first surfaces 181a and 181b.

The first and second bonding portions 160a and 160b may come into contact with the first surfaces, and ultrasonic waves U are applied, so that the first and second bonding portions 160a and 160b and the first surfaces 181a and 181b of the first and second external terminals 180a and 180b may be electrically connected to each other.

According to this embodiment, each of the first and second bonding portions 160a and 160b is a combination of lead terminal portions. Therefore, the first and second bonding portions 160a and 160b can be easily coupled with the first and second external terminals 180a and 180b, respectively, and damage to a package, caused when ultrasonic waves are applied, can be reduced.

Furthermore, coupling between the first and second bonding portions 160a and 160b and the first and second external terminals 180a and 180b can be improved, leakage of electrolyte can be prevented, and resistance between the first and second bonding portions and the first and second external terminals can be reduced.

Furthermore, as described above, the first and second bonding portions 160a and 160b may have curved portions, thereby improving ultrasonic welding.

Then, as shown in FIG. 4C, the lower case 170a having the electric double layer capacitor cell A mounted therein is filled with an electrolyte. As for the electrolyte, an aqueous electrolyte or a non-aqueous electrolyte may be used. The upper cap 170b is then mounted on the lower case 170a in order to cover the storage space 171.

As set forth above, according to exemplary embodiments of the invention, an electric double layer capacitor cell has a bonding portion formed by combining a plurality of lead terminal portions. The bonding portion may be connected to an external terminal of a package by ultrasonic welding.

The bonding portion, which is a combination of the plurality of lead terminal portions, can be easily coupled with the external terminal and reduce damage to the package when ultrasonic waves are applied thereto. Furthermore, coupling between the bonding portion and the external terminal can be improved, leakage of an electrolyte can be prevented, and resistance between the bonding portion and the external terminal can be reduced.

While the present invention has been shown and described in connection with the exemplary embodiments, it will be apparent to those skilled in the art that modifications and variations can be made without departing from the spirit and scope of the invention as defined by the appended claims.

What is claimed is:

1. An electric double layer capacitor cell comprising:
a plurality of electric double layer capacitor unit cells stacked upon each other,
wherein each of the plurality of electric double layer capacitor unit cells comprises first and second current collectors having first and second lead terminal portions, respectively, first and second electrodes provided on the first and second current collectors, respectively, and a separator provided between the first and second electrodes, and
the first and second electrode lead terminal portions each are combined into one to provide first and second bonding portions being connected to external terminals provided to apply electricity to the electric double layer capacitor unit cells.

2. The electric double layer capacitor cell of claim 1, wherein each of the first and second bonding portions is combined by rolling.

3. The electric double layer capacitor cell of claim 1, wherein the first and second bonding portions have curved portions.

4. An electric double layer capacitor package comprising:
an external case having a storage space therein and formed of insulating resin;
first and second external terminals buried within the external case and each having a first surface being exposed to the storage space and a second surface being exposed to an outside area of the external case; and
an electric double layer capacitor cell disposed in the storage space and having a plurality of electric double layer capacitor unit cells stacked upon each another,
wherein each of the plurality of electric double layer capacitor unit cells comprises first and second current collectors having first and second lead terminal portions, respectively, first and second electrodes provided on the first and second current collectors, respectively, and a separator provided between the first and second electrodes, the first and second lead terminal portions each are combined into one to provide first and second bonding portions, respectively, and the first and second bonding portions are electrically connected to the first surfaces of the first and second external terminals, respectively.

5. The electric double layer capacitor package of claim 4, wherein the first and second bonding portions are combined by rolling.

6. The electric double layer capacitor package of claim 4, wherein the first and second bonding portions have curved portions.

7. The electric double layer capacitor package of claim 4, wherein the first and second bonding portions are connected to the first surfaces of the first and second external terminals, respectively, by ultrasonic welding.

8. The electric double layer capacitor package of claim 4, wherein the external case is provided by molding the insulating resin and the first and second external terminals into a single body by insert injection molding.

9. The electric double layer capacitor package of claim 4, wherein the first and second external terminals are provided on the same surface of the external case.

10. The electric double layer capacitor package of claim 4, wherein the external case has a storage space having an open top, a lower case having the first and second external terminals buried therein, and an upper cap mounted on the lower case to cover the storage space.

11. A method of manufacturing an electric double layer capacitor cell, the method comprising:
stacking a plurality of electric double layer capacitor unit cells each having first and second current collectors including first and second lead terminal portions, respectively, first and second electrodes formed on the first and second current collectors, respectively, and a separator formed between the first and second electrodes; and
combining the first and second lead terminal portions into one to form respective first and second bonding portions, the first and second bonding portions connected to external terminals provided to apply electricity to the electric double layer capacitor unit cells.

12. The method of claim 11, wherein the first and second bonding portions are formed by rolling.

13. A method of manufacturing an electric double layer capacitor package, the method comprising:
molding insulating resin and first and second external terminals into a single body to thereby form a lower case having a storage space with an open top so that the first and second external terminals have first surfaces exposed to the storage space and second surfaces exposed to an outside area of the lower case;
stacking a plurality of electric double layer capacitor unit cells each having first and second current collectors including first and second lead terminal portions, respectively, first and second electrodes formed on the first and second current collectors, respectively, and a separator formed between the first and second electrodes;
combining the first and second lead terminal portions into one to form respective first and second bonding portions to thereby prepare an electric double layer capacitor cell having the first and second bonding portions;
disposing the electric layer capacitor cell within the storage space;
electrically connecting the first and second bonding portions to the first surfaces of the first and second external terminals; and
mounting an upper cap on the lower case to cover the storage space.

14. The method of claim 13, wherein the first and second bonding portions are formed by rolling.

15. The method of claim 13, wherein the first and second boding portions and the first surfaces of the first and second external terminals are connected by ultrasonic welding.

16. The method of claim 13, wherein the lower case is formed by insert injection molding.
